(19) United States
(12) Patent Application Publication
(10) Pub. No.: US 2026/0139600 A1
(43) Pub. Date: May 21, 2026

(54) MACHINABLE COATING FOR DAMPING

(71) Applicant: RTX Corporation, Farmington, CT (US)

(72) Inventors: Timothy J. Harding, Wethersfield, CT (US); Robert A. White, III, Meriden, CT (US); John E. Holowczak, South Windsor, CT (US)

(21) Appl. No.: 18/950,531

(22) Filed: Nov. 18, 2024

Related U.S. Application Data
(62) Division of application No. 18/169,176, filed on Feb. 14, 2023, now abandoned.

(51) Int. Cl. F01D 5/26; F01D 5/28

(52) U.S. Cl. CPC F01D 5/26; F01D 5/282; F01D 5/284; F05D 2220/32; F05D 2230/10; F05D 2230/31; F05D 2240/80; F05D 2260/96; F05D 2300/6033

(57) ABSTRACT

A gas turbine engine blade includes a platform, an airfoil section extending from the platform in a first direction, a mount extending from the platform in a second direction opposite the first direction, and a damper deposited on one of the platform, the airfoil section, and the mount. A method of sizing a damper for a gas turbine engine blade is also disclosed.

### CROSS-REFERENCE TO RELATED APPLICATIONS

This application is a divisional of U.S. patent application Ser. No. 18/169,176 filed Feb. 14, 2023.

### BACKGROUND OF THE INVENTION

This application relates to a mount structure and turbine blade for use in a gas turbine engine turbine section.

Gas turbine engines are known, and in some examples include a fan delivering air into a bypass duct as propulsion air. The fan also delivers air into a compressor. Compressed air is delivered downstream to a combustor where it is mixed with fuel and ignited. Products of this combustion pass downstream over turbine rotors, driving them to rotate. The turbine rotors in turn rotate fan and compressor rotors.

As can be appreciated, the turbine section sees very high temperatures from the products of combustion. Thus, a good deal of effort is expended in trying to provide turbine components that can survive the high temperatures. Other types of engines may also benefit from high-temperature components.

One recent materials approach for providing turbine section components, and other components of an engine, is the use of ceramic matrix composites (“CMCs”). There is a need for improved adaptation of CMCs for use in engines.

### SUMMARY OF THE INVENTION

A gas turbine engine blade according to an exemplary embodiment of this disclosure, among other possible things includes a platform, an airfoil section extending from the platform in a first direction, a mount extending from the platform in a second direction opposite the first direction, and a damper deposited on one of the platform, the airfoil section, and the mount.

In a further example of the foregoing, the damper is machinable.

In a further example of any of the foregoing, the damper includes at least one of rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum oxygen-nitrogen, barium-magnesium aluminosilicate, hafnium oxides, hafnon, hafnium silicon oxides, alumina-stabilized zirconia, zirconium oxides, zircon, yttrium oxides such as yttria, and combinations thereof.

In a further example of any of the foregoing, the damper includes at least one of hafnon, zircon, and mullite.

In a further example of any of the foregoing, the blade is one of a ceramic matrix composite blade or a monolithic ceramic blade.

In a further example of any of the foregoing, the damper is on the platform.

In a further example of any of the foregoing, the damper is on a non-gas-path surface of the platform.

In a further example of any of the foregoing, the blade comprises a ceramic matrix composite.

In a further example of any of the foregoing, the blade comprises a monolithic ceramic material.

In a further example of any of the foregoing, there are no fasteners attaching the damper to the blade.

A method of sizing a damper for a gas turbine engine blade according to an exemplary embodiment of this disclosure, among other possible things includes determining the mass of a blade, depositing a damper onto the blade, determining a mass of the damper after the depositing step, and machining the damper to remove mass.

In a further example of the foregoing, the method also includes comparing a mass of the damper to a desired mass.

In a further example of any of the foregoing, the method also includes repeating the machining step if the mass of the damper is larger than the desired mass.

In a further example of any of the foregoing, the depositing is by at least one of plasma spray, slurry coating, chemical vapor deposition (CVD), physical vapor deposition, and electron beam physical deposition

In a further example of any of the foregoing, the machining is by grinding, ultrasonic machining, water guided laser, milling, or reaming.

In a further example of any of the foregoing, the blade is one of a ceramic matrix composite blade or a monolithic ceramic blade.

In a further example of any of the foregoing, the deposition attaches the damper to the blade without any fasteners.

In a further example of any of the foregoing, the blade includes an airfoil section, a platform, and a mount. The damper is deposited onto the platform.

In a further example of any of the foregoing, the damper is deposited onto a non-gas-path surface of the platform.

In a further example of any of the foregoing, the damper includes at least one of rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum oxygen-nitrogen, barium-magnesium aluminosilicate, hafnium oxides, hafnon, hafnium silicon oxides, alumina-stabilized zirconia, zirconium oxides, zircon, yttrium oxides such as yttria, and combinations thereof.

### BRIEF DESCRIPTION OF THE DRAWINGS

FIG. 1 schematically shows a gas turbine engine.

FIGS. 2A-C show alternate views of an example turbine blade for the gas turbine engine of FIG. 1.

FIG. 3 shows an example method of sizing a damper for a turbine blade such as the example blades of FIGS. 2A-B.

### DETAILED DESCRIPTION

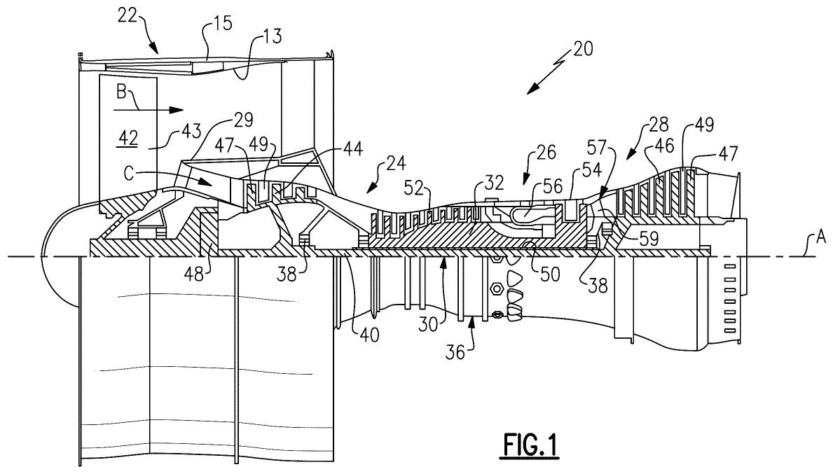

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. The engine 20 may incorporate a variable area nozzle for varying an exit area of the bypass flow path B and/or a thrust reverser for generating reverse thrust.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of vanes adjacent the rotatable airfoils. The rotatable airfoils are schematically indicated at 47, and the vanes are schematically indicated at 49.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption-also known as “bucket cruise Thrust Specific Fuel Consumption (‘TSFC’)”—is the industry standard parameter of lbm of fuel being burned divided by lbf of thrust the engine produces at that minimum point. The engine parameters described above, and those in the next paragraph are measured at this condition unless otherwise specified.

“Fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The fan pressure ratio is a spanwise average of the pressure ratios measured across the fan blade 43 alone over radial positions corresponding to the distance. The fan pressure ratio can be less than or equal to 1.45, or more narrowly greater than or equal to 1.25, such as between 1.30 and 1.40. “Corrected fan tip speed” is the actual fan tip speed in ft/sec divided by an industry standard temperature correction of [(Tram ° R)/(518.7° R)]^{0.5}. The corrected fan tip speed can be less than or equal to 1150.0 ft/second (350.5 meters/second), and can be greater than or equal to 1000.0 ft/second (304.8 meters/second).

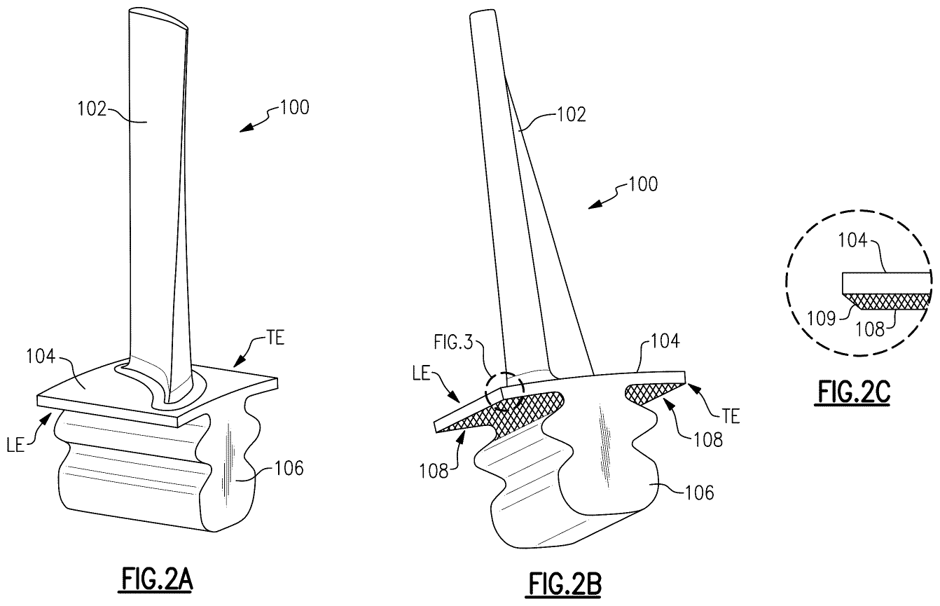

FIGS. 2A-B show an example blade 100 that can be used in, for example, the turbine section 28 of the engine 20. The blade 100 includes an airfoil section 102 that extends from a platform 104, and a mount 106 extending from the platform 104 in a direction opposite the direction of the airfoil section 102. In this example the mount 106 is a “fir-tree” mount though other geometries are contemplated. In general, the mount 106 has enlarged portions that are received in corresponding grooves of a rotor disk in a turbine 46/54 of the turbine section 28 to retain the blade 100 in the rotor disk (not shown).

The blades 100 are formed of a composite material such as a polymer matrix composite (“PMC”), metal matrix composite (“MMC”), ceramic matrix composite (“CMC”), or a monolithic ceramic. A CMC material may be comprised of one or more ceramic reinforcements, such as fibers, in a ceramic matrix. Example of ceramic matrices are silicon-containing ceramics, such as but not limited to, a silicon carbide (SiC) matrix or a silicon nitride (Si3N4) matrix. Example ceramic reinforcement of the CMC are silicon-containing ceramic fibers, such as but not limited to, silicon carbide (SiC) fiber or silicon nitride (Si3N4) fibers. The CMC may be, but is not limited to, a SiC/SiC ceramic matrix composite in which SiC fiber plies are disposed within a SiC matrix. The fibers may be arranged in fiber plies, is an ordered arrangement of the fiber tows/yarns relative to one another, such as a 2D/3D weave, braid, knit, or a nonwoven structure. A monolithic ceramic does not contain fibers or reinforcement and is comprised of a single material. Example monolithic ceramics include silicon-containing ceramics, such as silicon carbide (SiC) or silicon nitride (Si3N4).

Each blade 100 may include a combination of the aforementioned materials. For instance the airfoil section may be a CMC while the mount 106 is metallic or has metallic components.

During operation of the engine 20, the blade 100 may be subject to vibratory forces. Damping these vibratory forces is typically achieved by attaching a damper to the blade. The damper has a mass and geometry, and is attached at a particular location of the blade 10, selected to reduce vibratory loads on the blade 100. However, it would be beneficial to achieve damping of the vibratory loads without needing to attach separate structures to the blade 100, as this process increases cost and complexity of manufacturing the blade 100 or retrofitting it in the event damping is needed.

Accordingly, the present blade 100 includes a damper 108 deposited directly onto the blade 100. That is, there are no fasteners attaching the damper 108 to the blade 100. The damper 108 is attached to the blade 100 by virtue of the deposition process.

More specifically, the damper 108 comprises a machinable material deposited in a discrete area of the blade 100. That is, the damper 108 is “machinable” in that it can be subject to grinding, ultrasonic machining, water guided laser, milling, reaming, or another machining methods known in the art to reduce its thickness and/or smooth its surface without any adverse effects to its integrity. In this way, the geometry and mass of the damper 108 can be fine-tuned as will be discussed in more detail below.

The material of the damper 108 may include rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum-oxygen-nitrogen, barium-magnesium aluminosilicate, hafnium oxides such as hafnon, hafnium silicon oxides, alumina-stabilized zirconia, zirconium oxides such as zircon, yttrium oxides such as yttria, and combinations thereof. In a particular example, the material coating includes at least one of hafnon, zircon, and mullite.

In the example of FIGS. 2A-B, the damper 108 is located on the non-gas-path surface of the platform 104. The damper 108 may be on a leading edge (LE) side of the platform 104, a trailing edge (TE) side of the platform 104, or both. As clearly shown, the damper 108 is on an opposed side of the platform 104 from the airfoil. Because the damper 108 is in this example out of the gas path, it is less susceptible to foreign object damage and/or environmental degradation.

The damper 108 may optionally have a tapered edge 109 to form a smooth transition between the platform 104 and the damper 108, which improves the aerodynamic performance of the blade 100, as shown in the detail view of FIG. 2C.

The damper 108 can be deposited onto the blade 100 by any suitable method known in the art, such as plasma spray, slurry coating, chemical vapor deposition (CVD), physical vapor deposition, electron beam physical deposition, or others. In some examples, areas of the blade 100 outside of the discrete area of the damper 100 are masked prior the deposition of the damper 108.

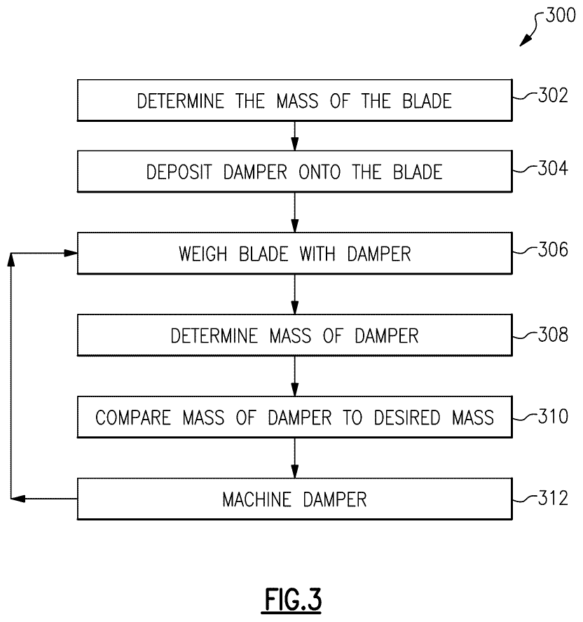

In one example, the damper is sized according to an iterative process schematically illustrated in FIG. 3. As shown in FIG. 3, an example method 300 of sizing the damper 108 determining the mass of the blade 100 in step 302. In step 304, an oversized damper 108 is deposited onto the blade 100. In step 306, the blade 100 with damper is weighed. In step 308, the mass of the damper 108 is determined by determining the mass of the blade 100 with damper 108 after step 304 and subtracting the mass of the blade 100 from step 302. In step 310, the mass of the damper from step 308 is compared to a predetermined desired damper 108 mass. If the mass is too high, steps 306 through 312 are repeated the damper 108 is machined as described above to remove mass from the damper 108. Steps 306, 308, and 310, and 312 are then repeated until the mass of the damper 108 is the desired mass.

As used herein, the term “about” has the typical meaning in the art, however in a particular example “about” can mean deviations of up to 10% of the values described herein.

Although a combination of features is shown in the illustrated examples, not all of them need to be combined to realize the benefits of various embodiments of this disclosure. In other words, a system designed according to an embodiment of this disclosure will not necessarily include all of the features shown in any one of the figures or all of the portions schematically shown in the figures. Moreover, selected features of one example embodiment may be combined with selected features of other example embodiments.

Although an embodiment of this invention has been disclosed, a worker of ordinary skill in this art would recognize that certain modifications would come within the scope of this disclosure. For that reason, the following claims should be studied to determine the true scope and content of this disclosure.

What is claimed is:

1. A method of sizing a damper for a gas turbine engine blade, comprising:
determining the mass of a blade;
depositing a damper onto the blade;
determining a mass of the damper after the depositing step; and
machining the damper to remove mass.

2. The method of claim 1, further comprising comparing a mass of the damper to a desired mass.

3. The method of claim 2, further comprising repeating the machining step if the mass of the damper is larger than the desired mass.

4. The method of claim 3, wherein the depositing is by at least one of plasma spray, slurry coating, chemical vapor deposition (CVD), physical vapor deposition, and electron beam physical deposition.

5. The method of claim 4, wherein the machining is by grinding, ultrasonic machining, water guided laser, milling, or reaming.

6. The method of claim 5, wherein the blade is one of a ceramic matrix composite blade or a monolithic ceramic blade.

7. The method of claim 5, wherein the deposition attaches the damper to the blade without any fasteners.

8. The method of claim 5, wherein the blade includes an airfoil section, a platform, and a mount, and wherein the damper is deposited onto a non-gas-path surface of the platform.

9. The method of claim 5, wherein the damper includes at least one of rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum oxygen-nitrogen, barium-magnesium aluminosilicate, hafnium oxides such as hafnon, hafnium silicon oxides, alumina-stabilized zirconia, zirconium oxides such as zircon, yttrium oxides such as yttria, and combinations thereof.

10. The method of claim 1, wherein the depositing is by at least one of plasma spray, slurry coating, chemical vapor deposition (CVD), physical vapor deposition, and electron beam physical deposition.

11. The method of claim 10, wherein the machining is by grinding, ultrasonic machining, water guided laser, milling, or reaming.

12. The method of claim 11, wherein the blade is one of a ceramic matrix composite blade or a monolithic ceramic blade.

13. The method of claim 11, wherein the deposition attaches the damper to the blade without any fasteners.

14. The method of claim 11, wherein the blade includes an airfoil section, a platform, and a mount, and wherein the damper is deposited onto a non-gas-path surface of the platform.

15. The method of claim 11, wherein the damper includes at least one of rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum oxygen-nitrogen, barium-magnesium aluminosilicate, hafnium oxides such as hafnon, hafnium silicon oxides, alumina-stabilized zirconia, zirconium oxides such as zircon, yttrium oxides such as yttria, and combinations thereof.

16. The method of claim 1, wherein the blade is one of a ceramic matrix composite blade or a monolithic ceramic blade.

17. The method of claim 1, wherein the deposition attaches the damper to the blade without any fasteners.

18. The method of claim 1, wherein the blade includes an airfoil section, a platform, and a mount, and wherein the damper is deposited onto a non-gas-path surface of the platform.

19. The method of claim 18, wherein the damper includes at least one of rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum oxygen-nitrogen, barium-magnesium aluminosilicate, hafnium oxides such as hafnon, hafnium silicon oxides, alumina-stabilized zirconia, zirconium oxides such as zircon, yttrium oxides such as yttria, and combinations thereof.

20. The method of claim 1, wherein the damper includes at least one of rare earth silicates, alkaline earth silicates, alkaline earth aluminosilicates, yttria-stabilized zirconia, alumina-stabilized zirconia, mullite, titania, chromia, silicon, silicon oxides, silicon carbides, silicon oxycarbides, silicon nitride, silicon-aluminum oxygen-nitrogen, barium-magnesium aluminosilicate, hafnium oxides such as hafnon, hafnium silicon oxides, alumina-stabilized zirconia, zirconium oxides such as zircon, yttrium oxides such as yttria, and combinations thereof.
